(19) United States
(12) Patent Application Publication
(10) Pub. No.: US 2011/0119248 A1
(43) Pub. Date: May 19, 2011

(54) TOPIC IDENTIFICATION SYSTEM, TOPIC IDENTIFICATION DEVICE, CLIENT TERMINAL, PROGRAM, TOPIC IDENTIFICATION METHOD, AND INFORMATION PROCESSING METHOD

(75) Inventors: Yuichi Abe, Tokyo (JP); Akifumi Kashiwagi, Tokyo (JP)

(73) Assignee: Sony Corporation, Tokyo (JP)

(21) Appl. No.: 12/943,331

(22) Filed: Nov. 10, 2010

(30) Foreign Application Priority Data
Nov. 19, 2009 (JP) 2009-264239

(51) Int. Cl. G06F 17/30

(52) U.S. Cl. 707/710; 707/E17.108

(57) ABSTRACT

There is provided a network device including a topic identification device including a collecting unit for collecting location information of Web data related to a target topic arranged on a network, a storage unit for storing identical topic identifying information in association with one or more than two pieces of location information related to an identical target topic, which have been collected by the collecting unit, and an topic identification unit for obtaining link information contained in certain Web data, for searching location information from the storage unit using the link information, and for identifying topic identifying information associated with the searched location information.

### BACKGROUND OF THE INVENTION

1. Field of the Invention

The present invention relates to a topic identification system, a topic identification device, a client terminal, a program, a topic identification method, and an information processing method.

2. Description of the Related Art

Recently, with the development of information communication technology, various data has been transmitted/received via network. Especially with the growth of Web service such as blog, SNS (Social Network Service) and the like, it becomes easy for an ordinary internet user to send an opinion or comment on a network.

In such Web service, each user can freely create a title or an article to deliver Web data (an article on a network, for example), which makes it difficult to be determined to what kind of topic each of the Web data is related due to the different phrases and expressions.

For example, to Web data related to the drama “Buzzer Beater”, a user may put a title of “I watched the Buzzer Beater!”, while another user may put a title of “Drama: Buzzer Beater”. There may be another case where some may describe “Buzzer-bee” in short instead of the “Buzzer Beater”, and others may express the drama with the day of the week and time of the broadcasting time, such as “Mon. 9 drama”, or the like. Thus, even though being created for the same drama, Web data may contains various ways of expressions, which makes it difficult to determine whether multiple Web data having different expressions are about the same drama or not.

Regarding the issue above, Japanese Unexamined Patent Application Publication No. 2006-268201 discloses two methods to calculate a degree of similarity in a plurality of articles from RSS (RDF Site Summary) data that describes the outline of the body of the articles, and to determine whether these articles are based on the same topic. The first method is “a method of calculating a degree of similarity based on attribute values of an article”, which calculates the degree of similarity for each elements of two articles respectively, such as titles, URLs, updated date/time, authors and the like, to calculate the degree of similarity between the two articles by weighting and adding each of the degree of similarities. The second method is “a method of calculating a degree of similarity based on a link reference”, which downloads the body of the articles from URL contained in a Link tag of the outline of the article, and calculates the degree of similarity between the links contained in the downloaded body of the articles.

### SUMMARY OF THE INVENTION

However, the above-mentioned “method of calculating a degree of similarity based on attribute values of an article” needs to calculate the degree of similarity between the same attributes, and cannot be applied if attributes of the data are not defined. If each elements of articles are written in XML (eXtensible Markup Language) format, it is possible to specify attributes such as title, URL, updated date/time, author, and the like by an attribute name (tag name) and an attribute value (tag value). On the contrary, articles written in HTML are difficult to compare each attributes between them, since HTML which is a markup language for describing Web pages does not have an attribute name of data. Even if some attributes can be extracted, expressions and phrases would be changing with the time or with a boom, which are difficult to be calculated its degree of similarities having regard to the differences in expressions. Further, regarding input of the attribute values, there should be input errors such as wrong letters, omitted letters, or the like, since each user can freely input the attribute values, which makes the calculation of the degree of similarities more difficult.

Moreover, the above-mentioned “method of calculating a degree of similarity based on a link reference” had an issue that the degree of similarity may be underestimated when the two articles contain different link information related to the same topic. For example, as link information included in an article on the drama “Buzzer Beater”, it is easy to think of link information referred to the official website of the drama “Buzzer Beater”, however, there are more other link information to various websites, such as link information to an item of the “Buzzer Beater” in an online encyclopedia, or the like.

In light of the foregoing, it is desirable to provide a topic identification system, a topic identification device, a client terminal, a program, a topic identification method, and an information processing method, which are novel and improved, and which are capable of identifying topic of Web data arranged on a network with higher accuracy.

According to an embodiment of the present invention, there is provided a topic identification system including a client terminal that includes a link information extraction unit for extracting link information contained in Web data arranged on a network, and a communication unit for transmitting the link information extracted by the link information extraction unit, and a topic identification device including a collecting unit for collecting location information of Web data related to a target topic, a storage unit for storing identical topic identifying information in association with one or more than two pieces of location information related to an identical target topic, which have been collected by the collecting unit, a receiving unit for receiving the link information transmitted from the communication unit of the client terminal, an identification unit for searching location information from the storage unit using the link information received by the receiving unit, and for identifying topic identifying information associated with the searched location information, and a transmitting unit for transmitting the topic identifying information identified by the identification unit to the client terminal.

The collecting unit may calculate a degree of importance of each of the collected location information, and determines whether the degree of importance of each of the location information exceeds a prescribed benchmark. And the storage unit may store the topic identifying information in association with the location information determined that the degree of importance has exceeded the prescribed benchmark.

The identification unit may search, from the storage unit, location information that is identical to the link information received by the receiving unit, and searches location information that is partially identical to the link information in a case where there has been found no location information that is identical to the link information.

The collecting unit may collect location information of Web data related to the target topic based on keywords of the target topic. The storage unit may further store one or more than two pieces of location information related to an identical target topic, which have been collected by the collecting unit, in association with keywords of the target topic. The identification unit may search, from the storage unit when a keyword is received from the client terminal, location information associated with topic identifying information containing the keyword. And the transmitting unit may transmit the location information searched by the identification unit to the client terminal.

The client terminal may further include a content storage unit for storing content in association with topic identifying information, and a search unit for searching, from the content storage unit, content associated with the topic identifying information transmitted by the topic identification device.

The client terminal may transmit location information contained in metadata of the content to the topic identification device, may receive topic identifying information identified through a search using the location information from the topic identification device, and may cause the storage unit to store the content in association with the received topic identifying information.

According to another embodiment of the present invention, there is provided a topic identification device including a collecting unit for collecting location information of Web data related to a target topic arranged on a network, a storage unit for storing identical topic identifying information in association with one or more than two pieces of location information related to an identical target topic, which have been collected by the collecting unit, and an identification unit for obtaining link information contained in certain Web data, for searching location information from the storage unit using the link information, and for identifying topic identifying information associated with the searched location information.

According to another embodiment of the present invention, there is provided a client terminal including a link information extraction unit for extracting link information contained in Web data arranged on a network, a receiving unit for transmitting the link information extracted by the link information extraction unit to a topic identification device storing identical topic identifying information in association with location information of Web data related to an identical target topic, and for receiving topic identifying information identified through a search using the link information from the topic identification device, a content storage unit for storing content in association with topic identifying information, and a search unit for searching, from the content storage unit, content associated with topic identifying information received from topic identification device.

According to another embodiment of the present invention, there is provided a program causing a computer to function as a collecting unit for collecting location information of Web data related to a target topic arranged on a network, a storage unit for storing identical topic identifying information in association with one or more than two pieces of location information related to an identical target topic, which have been collected by the collecting unit, and an identification unit for obtaining link information contained in certain Web data, for searching location information from the storage unit using the link information, and for identifying topic identifying information associated with the searched location information.

According to another embodiment of the present invention, there is provided a program causing a computer to function as a link information extraction unit for extracting link information contained in Web data arranged on a network, and a receiving unit for transmitting the link information extracted by the link information extraction unit to a topic identification device storing identical topic identifying information in association with location information of Web data related to an identical target topic, and for receiving topic identifying information identified through a search using the link information from the topic identification device, a content storage unit for storing content in association with topic identifying information, and a search unit for searching, from the content storage unit, content associated with topic identifying information received from topic identification device.

According to another embodiment of the present invention, there is provided a topic identifying method including the steps of collecting location information of Web data related to a target topic arranged on a network, storing identical topic identifying information into a storage medium in association with one or more than two pieces of location information related to an identical target topic, which have been collected. obtaining link information contained in certain Web data, and for searching location information from the storage unit using the link information, and identifying topic identifying information associated with the searched location information.

According to another embodiment of the present invention, there is provided an information processing method including the steps of extracting link information contained in Web data arranged on a network, transmitting the extracted link information to a topic identification device storing identical topic identifying information in association with location information of Web data related to an identical target topic, receiving topic identifying information identified through a search using the link information from the topic identification device, and searching content associated with topic identifying information received from the topic identification device, from a storage medium storing content in association with topic identifying information.

According to the embodiments of the present invention described above, it is possible to identify a topic of Web data arranged on a network with higher accuracy.

### BRIEF DESCRIPTION OF THE DRAWINGS

FIG. 1 is an explanatory diagram for illustrating a configuration of a topic identification system according to an embodiment of the present invention;

FIG. 2 is an explanatory diagram for illustrating a concrete example of Web data;

FIG. 3 is a block diagram for illustrating a hardware configuration of a client terminal;

FIG. 4 is a function block diagram for illustrating a configuration of a client terminal and a topic identification device according to the embodiment;

FIG. 5 is a flow chart for illustrating how the topic identification device collects data for topic identification;

FIG. 6 is an explanatory diagram for illustrating a concrete example of a target topic list;

FIG. 7 is an explanatory diagram for illustrating a concrete example of data for topic identification;

FIG. 8 is a flow chart for illustrating how the client terminal associates each content with a topic ID;

FIG. 9 is a sequence diagram for illustrating a process of topic identification by the client terminal and the topic identification device; and

FIG. 10 is a sequence diagram for illustrating a modified example of an operation by the topic identification system.

### DETAILED DESCRIPTION OF THE EMBODIMENT(S)

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Additionally, in this specification and drawings, a plurality of structural elements having substantially the same functional configuration are sometimes distinguished from each other by a different alphabet letter added to a same numeral. For example, a plurality of structures having substantially the same functional configuration are distinguished from each other as necessary by being referred to as clients 20A, 20B. However, in case it is not necessary to distinguish between a plurality of structural elements having substantially the same functional configuration, only a same numeral is added thereto. For example, in case it is not particularly necessary to distinguish between the clients 20A and 20B, they will be collectively referred to as the clients 20.

Preferred embodiments of the present invention will be described hereinafter in the following order:

1. Configuration of a topic identification system according to the embodiment of the present invention

2. Hardware configuration of a client terminal

3. Functions of the client terminal and the topic identification device

4. Explanations on each process
4-1. Collecting data for topic identification
4-2. Registering a topic ID associated with each of content
4-3. Process of topic identification

5. Modified example

6. Conclusion

### 1. CONFIGURATION OF A TOPIC IDENTIFICATION SYSTEM ACCORDING TO THE EMBODIMENT OF THE PRESENT INVENTION

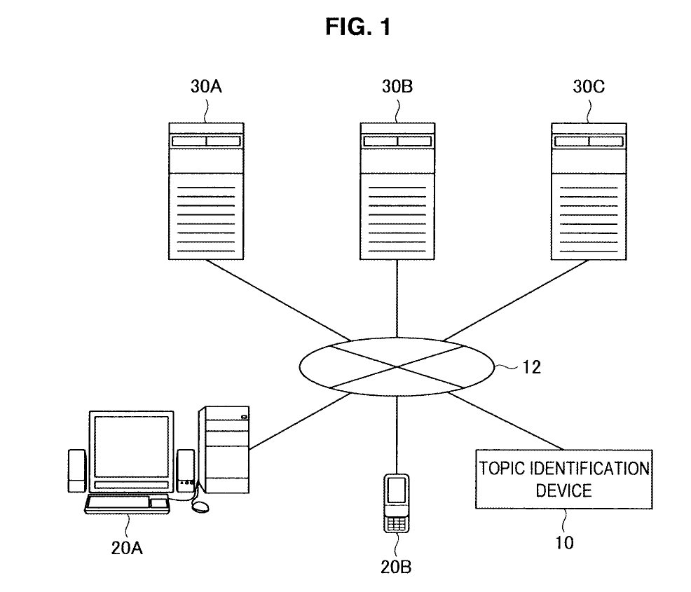

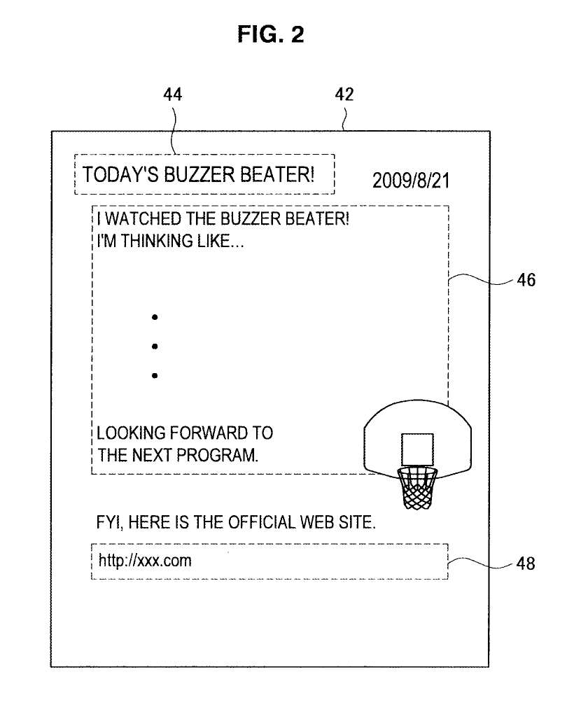

At first, referring to FIGS. 1 and 2, a configuration of a topic identification system 1 according to an embodiment of the present invention will be explained.

FIG. 1 is an explanatory diagram for illustrating a configuration of a topic identification system 1 according to an embodiment of the present invention. As shown in FIG. 1, the topic identification system 1 according to the present embodiment includes a topic identification device 10, a network 12, client terminals 20A and 20B, Web servers 30A, 30B and 30C.

The Web server 30 stores Web data created in HTML format, and transmits the Web data to the client terminal 20 in response to a request from the client terminal 20. The Web server 30 corresponds to a blog server or a SNS server, for example, while the Web data corresponds to a blog article or a SNS site. Other examples of the Web data are various data, such as an official website regarding some topic, an online encyclopedia, and the like. Note that three Web servers 30A, 30B and 30C only are illustrated in FIG. 1, however, several hundreds and thousands of the Web servers 30 may be connected to the network 12.

Hereinafter, a concrete example of the Web data will be explained with reference to FIG. 2.

FIG. 2 is an explanatory diagram for illustrating a concrete example of Web data. The Web data 42 shown in FIG. 2 includes a title 44, an article body 46, and link information 48. Opinions and comments are often raised to a specific topic in the article body 46, and as for explanations of the content of the topic, other websites such as an official website, an online encyclopedia, news website, and the like are often referred by the link information 48. That is, URLs of other websites such as an official website, an online encyclopedia, a news website and the like are often contained in the Web data as link information. Moreover, the Web data often refers to images or movies contained in the other websites in addition to URLs of the other websites. In that case, image tags or the like in a HTML description includes URLs of the official website, the online encyclopedia, the news website and the like.

The client terminal 20 is connected to the Web server 30 via the network 12, and is able to obtain Web data from the Web server 30 to display. Note that the network 12 is a wired or wireless transmission path for information transmitted from devices that are connected to the network 12. For example, the network 12 may include a public network such as the Internet, a telephone network, or a satellite network, various local area networks (LANs) including Ethernet (registered trademark), or a wide area network (WAN). Furthermore, the network 12 may include a leased line network such as an Internet protocol-virtual private network (IP-VPN).

Moreover, the client terminal 20 executes an application necessary to identify which topic is related to the Web data such as a blog and a SNS site released to public by the Web server 30. The application necessary to identify a topic is not specially limited, but in the present specification, an emphasis is placed on a case where this application is a search application that searches contents related to a topic of a certain Web data from a lot of contents which the client terminal 20 stores.

With the recent trend of a larger capacity and less expensive of HDD (Hard Disk Drive), the client terminal 20 can store tremendous amount of contents. However, the more contents are stored, the harder the user selects a content. In light of the foregoing, the above-mentioned search application for recommending a high-profile topic being popular in blogs or SNS sites to a user has been expected. This search application will be explained in detail later in “4. Explanations on each process”.

Note that in this specification, it is assumed a case where the content is a movie data such as a movie, a television program, a video program or the like, however, the content is not limited to these examples. For example, the content may be music data such as music, a radio program or the like, a still image data, a game, software, or the like.

FIG. 1 shows a personal computer (PC) as the client terminal 20A, and a cellar phone as the client terminal 20B, however, the client 20 is not limited to either a PC nor a cellar phone. For example, the client terminal 20 may be an information processing apparatus such as a home video processing device (a DVD recorder, a video cassette recorder, or the like), a personal digital assistant (PDA), a home game machine, a home appliance, or the like. Also, the client terminal 20 may be an information processing apparatus such as a Personal Handyphone System (PHS), a portable audio playback device, a portable video processing device, a portable game machine, or the like.

The topic identification device 10 identifies a topic of Web data requested in response to a request from the client terminal 20, and transmits information indicating the identified topic (a topic ID) to the client terminal 20. The topic identification device 10 performs a process of collecting data for topic identification necessary to identify a topic in advance in order to realize such a process of topic identification. The process of collecting data for topic identification will be explained in detail later in “4-1. Collecting data for topic identification”, and the process of topic identification will be explained in detail later in “4-3. Process of topic identification”.

In the example shown in FIG. 1, the topic identification device 10 is arranged on the network 12 as a device different from the client terminal 20 that performs an application. That is, the topic identification device 10 is open to the public on the network 12 in the form of a Web service, and this enables a plurality of the client terminals 20 can access to the topic identification device 10. Moreover, the topic identification device 10 releases an API (Application Program Interface) for providing functions of topic identification, to the public, which makes the functions of topic identification available to be used easily from the client terminals 20.

As described above, by releasing the topic identification device 10 to the public on the network 12 as a Web service, the functions of topic identification can be utilized by a plurality of the client terminals 20, however, the present invention is not limited to this example. For example, in the technical scope of the present invention, the client terminals 20 can also be implemented with both functions of topic identification and applications.

### 2. HARDWARE CONFIGURATION OF A CLIENT TERMINAL

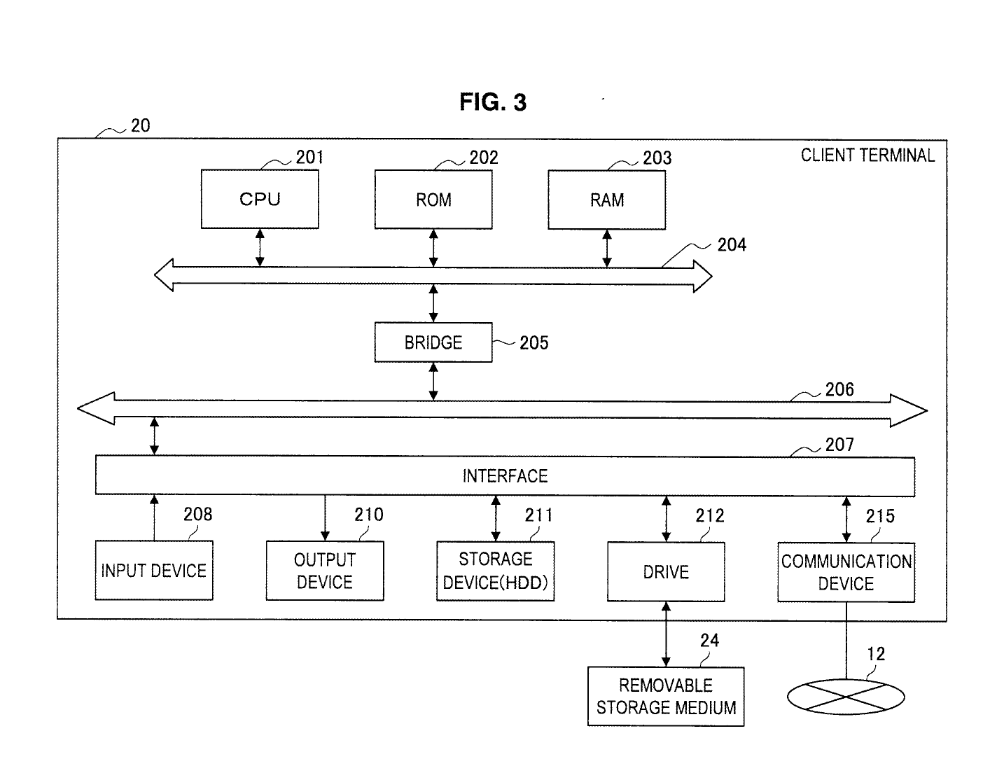

Heretofore, referring to FIGS. 1 and 2, the configuration of the topic identification system 1 according to an embodiment of the present invention has been explained. Next, referring to FIG. 3, an explanation will be given on a hardware configuration of the client terminal 20 included in the topic identification system 1.

FIG. 3 is a blog diagram for illustrating a hardware configuration of a client terminal 20. The client terminal 20 includes a CPU (Central Processing Unit) 201, a ROM (Read Only Memory) 202, a RAM (Random Access Memory) 203, and a host bus 204. Moreover, the client terminal 20 includes a bridge 205, an external bus 206, an interface 207, an input device 208, an output device 210, a storage device (HDD) 211, a drive 212, and a communication device 215.

The CPU 201 functions as an arithmetic processing unit and a controlling unit and controls general operation in the client terminal 20 in accordance with a variety of programs. The CPU 201 may be a microprocessor. The ROM 202 stores the programs and arithmetic parameters to be used by the CPU 201. The RAM 203 temporarily stores programs to be used during the operation of the CPU 201, parameters to vary appropriately during the operation thereof and the like. These are mutually connected by the host bus 204 constituted with a CPU bus and the like.

The host bus 204 is connected to the external bus 206 such as a peripheral component interconnect/interface (PCI) bus via the bridge 205. Here, it is not necessary to separately constitute the host bus 204, the bridge 205 and the external bus 206. The functions thereof may be mounted on a single bus.

The input device 208 is constituted with an input means such as a mouse, a keyboard, a touch panel, a button, a microphone, a switch and a lever to input information by a user, and an input controlling circuit to generate an input signal based on the input by the user and to output the signal to the CPU 201. The user of the client terminal 20 can input a variety of data and instruct the client terminal 20 to process operation by operating the input device 208.

The output device 210 includes a display device such as a cathode ray tube (CRT) display device, a liquid crystal display (LCD) device, an organic light emitting diode (OLED) device and a lamp. Further, the output device 210 includes an audio output device such as a speaker and a headphone. The output device 210 outputs a reproduced content, for example. Specifically, the display device displays various types of information such as reproduced video data with texts or images. Meanwhile, the audio output device converts reproduced audio data and the like into audio and outputs the audio.

The storage device 211 is a device for data storage configured to be an example of a memory unit of the client terminal 20 according to the present embodiment. The storage device 211 may include a storage medium, a recording device to record data at the storage medium, a reading device to read the data from the storage medium, and a deleting device to delete the data recorded at the storage medium. The storage device 211 is configured with a hard disk drive (HDD), for example. The storage device 211 drives the hard disk and stores programs to be executed by the CPU 201 and a variety of data.

The drive 212 is a reader/writer for the storage medium and is incorporated by or externally attached to the client terminal 20. The drive 212 reads the information stored at a mounted removal storage medium 24 such as a magnetic disk, an optical disk, a magneto-optical disk and a semiconductor memory and outputs the information to the RAM 203. The drive 212 can write information onto the removal storage medium 24.

The communication device 215 is a communication interface constituted with a communication device and the like to be connected to the network 12, for example. Here, the communication device 215 may be a wireless local area network (LAN) compatible communication device, a LTE (Long Term Evolution) compatible communication device or a wired communication device to perform communication with a cable.

The hardware configuration of the client terminal 20 has been explained referring to FIG. 30 above. The hardware of the topic identification device 10 may have substantially the same function and structure with the client terminal 20, therefore, the explanation of the hardware of the topic identification device 10 will be omitted.

### 3. FUNCTIONS OF THE CLIENT TERMINAL AND THE TOPIC IDENTIFICATION DEVICE

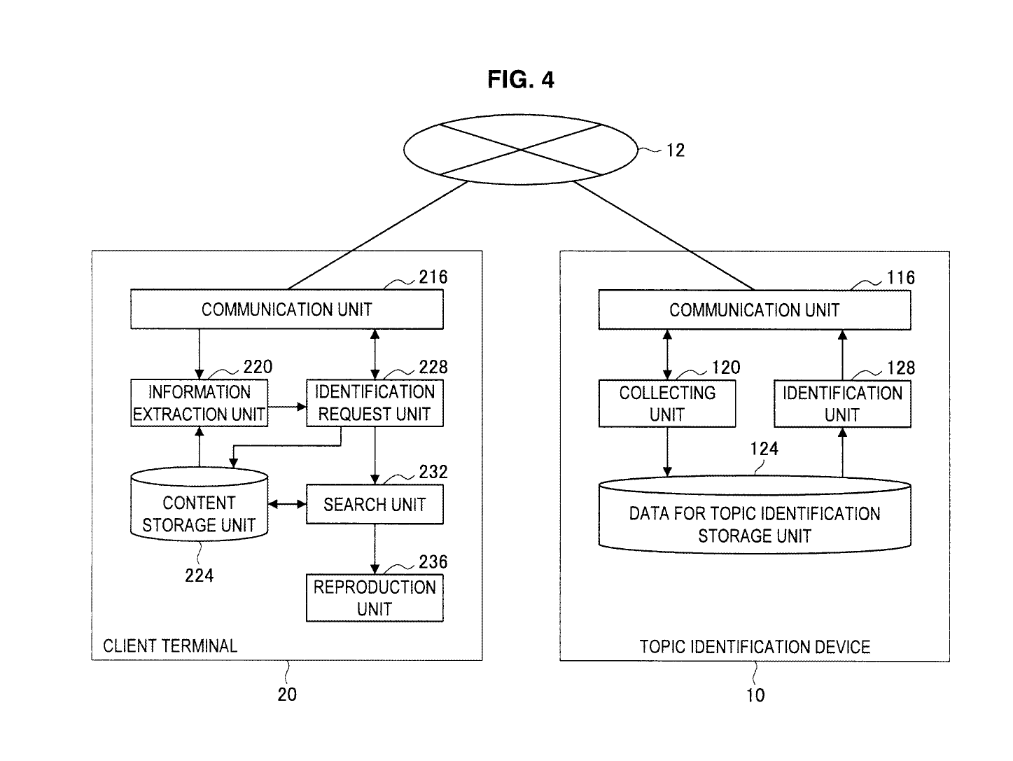

Next, the functions of the client terminal 20 and the topic identification device 10 will be briefly explained with reference to FIG. 4.

FIG. 4 is a function block diagram for illustrating a configuration of the client terminal 20 and the topic identification device 10 according to the embodiment. As shown in FIG. 4, the topic identification device 10 includes a communication unit 116, a collecting unit 120, a data for topic identification storage unit 124, and a identification unit 128.

The communication unit 116 functions as a transmitting unit and a receiving unit which transmits/receives data with the client terminals 20 and the Web server 30 on the network 12. The collecting unit 120 collects URL (location information) related to a target topic as data for topic identification. Then the storage unit 124 stores the collected data for topic identification. Moreover, the identification unit 128 identifies a topic of Web data requested from the client terminal 20 using the data for topic identification stored by the data for topic identification storage unit 124.

The client terminal 20 includes a communication unit 216, a information extraction unit 220, a content storage unit 224, a identification request unit 228, a search unit 232, and a reproduction unit 236.

The communication unit 116 functions as a transmitting unit and a receiving unit which transmits/receives data with the topic identification device 10 and the Web server 30 on the network 12. The information extraction unit 220 (a link information extraction unit, a URL extraction unit) extracts link information included in the Web data that is obtained from the Web server 30. For example, when the information extraction unit 220 obtains a Web data 42 shown in FIG. 2 from the Web server 30, the information extraction unit 220 extracts link information 48 that is “http://xxx.com” from the Web data 42.

The content storage unit 224 is a storage medium to store the content which the client terminal 20 obtained. The content storage unit 224 stores each content in association with a topic ID that is identified by the topic identification device 10. Note that the client terminal 20 can obtain contents through terrestrial digital broadcasting, cable TV broadcasting, BS (Broadcasting Satellite) digital broadcasting, CS (Communication Satellite) digital broadcasting or the like. Moreover, the client terminal 20 may obtain contents that is distributed via the network 12.

Additionally, the content storage unit 224 may be a storage medium such as a non-volatile memory, a magnetic disk, an optical disk, a magneto optical (MO) disk, and the like. The non-volatile memory may be an electrically erasable programmable read-only memory (EEPROM), and an erasable programmable ROM (EPROM), for example. Also, the magnetic disk may be a hard disk, a discoid magnetic disk, and the like. Also, the optical disk may be a compact disc (CD), a digital versatile disc recordable (DVD-R), a Blu-ray disc (BD; registered trademark), and the like.

The identification request unit 228 requests the topic identification device 10 for a topic identification of the Web page obtained by the information extraction unit 220 to obtain information indicating a topic of the Web page from the topic identification device 10. Specifically, the identification request unit 228 transmits the link information extracted by the information extraction unit 220, and obtains the topic ID identified in the topic identification device 10 based on the link information from the topic identification device 10.

The search unit 232 searches, from the content storage unit 224, a content associated with the topic ID that is obtained from the topic identification device 10 by the identification request unit 228, and the reproduction unit 236 reproduces the content searched by the search unit 232. Note that the client terminal 20 may display a list including the content searched by the search unit 232 to encourage a user to select the content choosing from the list.

### 4. EXPLANATIONS ON EACH PROCESS

Heretofore, the functions of the client terminal 20 and the topic identification device 10 have been schematically explained with reference to FIG. 4. Next, each process, such as collecting data for topic identification, registration of a topic ID associated with each of content, and topic identification, will be explained in detail.

(4-1. Collecting Data for Topic Identification)

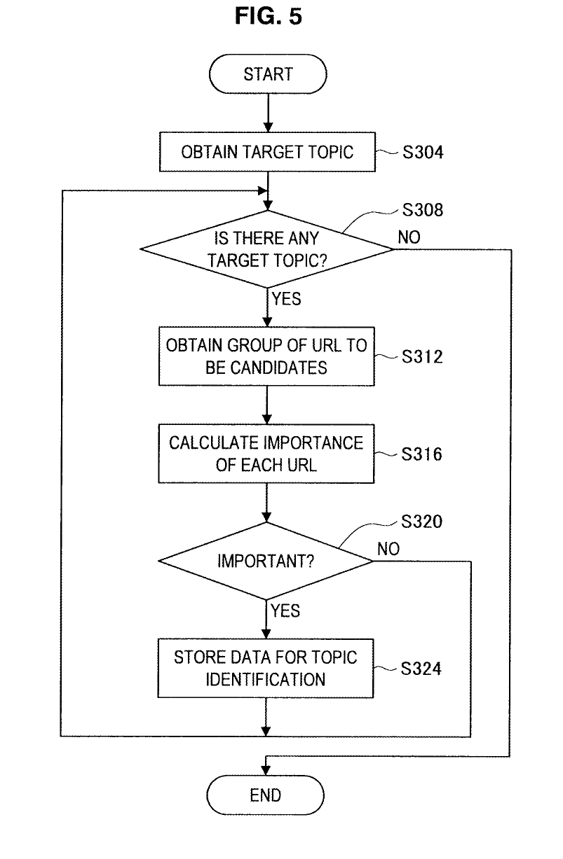

FIG. 5 is a flow chart for illustrating how the topic identification device 10 collects data for topic identification. This collecting process is a process independent from the process of topic identification, and performed regularly to update the data for topic identification.

As shown in FIG. 5, the collecting unit 120 of the topic identification device 10 obtains a target topic at first, and generates a target topic list (S304). For example, the collecting unit 120 collects titles of television programs on the network 12 in order to generate the target topic list related to the television programs. Specifically, the collecting unit 120 may generate the target topic list by collecting items of the television programs from an online encyclopedia.

Instead, the collecting unit 120 may collect RSS data provided by the broadcasting station, and may generate the target topic list based on titles of the latest television programs included in the RSS data. Moreover, the collecting unit 120 may receive a broadcast wave to extract program titles from SI (Service Information) contained in the broadcast wave, and may generate the target topic list. Further, when a user or a broadcasting station registers a program title as a target topic to the topic identification device 10 at a time of broadcasting a new program, the collecting unit 120 may generate the target topic list using the registered program titles.

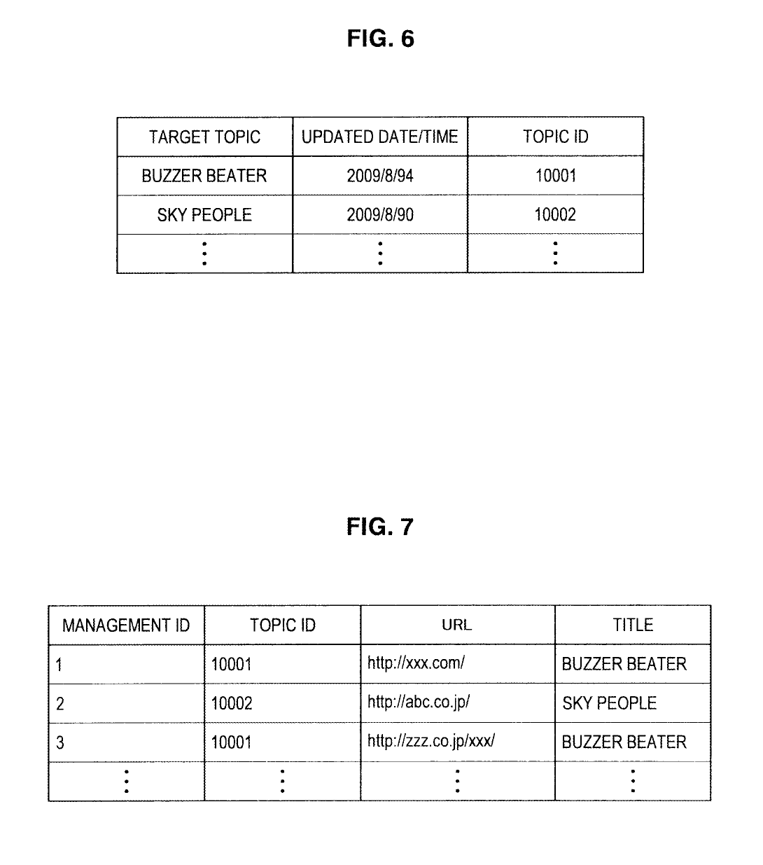

FIG. 6 is an explanatory diagram for illustrating a concrete example of a target topic list. As shown in FIG. 6, the target topic list includes target topics, updated dates/times, and topic IDs. The target topic is a program title obtained in the method above described as an example. The updated date/time is the date and time when the previous update was performed regarding the target topic. The topic ID is topic identifying information to be assigned uniquely to each target topic.

The collecting unit 120 transitions to a process indicated in S312 when the target topic list shown in FIG. 6 has been obtained, that is, when there is a target topic (S308). Note that processes after S312 may perform for each target topic included in the target topic list, or may perform only for the target topic which have not been updated over certain period of time.

Subsequently, the collecting unit 120 obtains a candidate for URL of the Web data regarding the target topic included in the target topic list (S312). Here, the Web data regarding to the target topic is a kind of Web data which includes information of the target topic, and may be an item page of the target topic, for example, in the official website of the target topic or the online encyclopedia.

More specifically, when the target topic is the drama the “Buzzer Beater”, there can be listed the official website of the “Buzzer Beater” provided by the broadcast station, an item page regarding the “Buzzer Beater” in the online encyclopedia, a blog by a staff of the “Buzzer Beater”, or the like as the Web data regarding the target topic. Moreover, when to identify the topic in more detail such as “the third story” of the “Buzzer Beater”, a page of the outline of “the third story” in the official website, or the like may corresponds to the Web data regarding the target topic.

Moreover, the URL of the Web data regarding the target topic may include an URL of image or movie image in addition to an URL of a Web page. For example, the URL of the Web data regarding to the target topic may be URL of a Trailer, an image of a scene, an interview page, or the like, which is provided in the official website.

Note that the collecting unit 120 may search the candidate for URL of the Web data above using the program title included in the target topic list as the target topic. For example, the collecting unit 120 can obtain a group of candidates for URL of the Web data related to the target topic by inputting the target topic as a keyword in a search service provided on the network 12.

After step S312, the collecting unit 120 calculates the degree of importance for each of the candidate for URL of the obtained Web data (S316). Here, the degree of importance would be overestimated for URL of the Web data linked to more number of Web data, and for URL of the Web data with more number of accesses. Note that services are offering to provide the degree of importance of each Web data on the network 12, and the collecting unit 120 may obtain the degree of importance of each candidate from these external services. Further, the collecting unit 120 may calculate the final degree of importance by weighting and adding each of the degree of importance for each candidate obtained from a plurality of external services.

Subsequently, the collecting unit 120 determines whether the degree of importance of each candidate exceeds the threshold to determine whether each candidate is important or not (S320). Then the data for topic identification storage unit 224 stores URL whose degree of importance exceeds the threshold among the group of URL candidates of the Web data relating to the target topic, in association with the topic ID of the target topic, as the data for topic identification (S324).

FIG. 7 is an explanatory diagram for illustrating a concrete example of data for topic identification. As shown in FIG. 7, the data for topic identification includes a management ID, a topic ID, URL, and a title. The management ID is an unique ID for managing the data for topic identification. The topic ID is topic identifying information which is uniquely assigned to each of target topic. The URL contained in the data for topic identification is an URL of Web page which is collected by the collecting unit 120 and is determined to be important. The title is a program title, for example. Specifically, the data for topic identification whose management ID is “1”, shown in FIG. 7, has a topic ID of “10001”, the URL of the Web data relating to the topic is “http://www.com/”, and the title is the “Buzzer Beater”.

Here, the topic identification device 10 according to the present embodiment stores Web pages in associating with the same topic ID, as far as the Web pages are related to the same target topic although the URLs are for different Web pages, in the above-described method. For example, as shown in FIG. 7, an URL of the data for the topic identification whose management ID is “1” is different from an URL of the data for the topic identification whose management ID is “3”, however, since both URLs are related to the same “Buzzer Beater”, they can be associated with the same topic ID of “10001”. This makes the topics of these Web data to be identified as the same even if link information contained in a plurality of Web data relating to the same topic are different.

Note that in FIG. 7, an example is shown a case where the data for topic identification includes a management ID, a topic ID, an URL, and a title, however, the present invention is not limited to this example. For example, the data for topic identification may not include a title, and may include a tag, detail information, casting information, or the like. Moreover, the title can be used as the topic identifying information instead of the topic ID.

As described above, the topic identification device 10 according to the present embodiment can collect URL candidates of the Web data relating to the target topic from the network 12. Further, the topic identification device 10 determines the degree of importance of each candidate, and stores only important candidates onto the data for topic identification storage unit 124 as the data for topic identification. This can prevent a case where URLs of Web data associated with low relativity to the target topic to be stored in the data for topic identification storage unit 124. As the result, only URL associated with the high relativity to the target topic can be stored as the data for topic identification, and the accuracy of the process of topic identification is expected to be improved.

(4-2. Registering a Topic ID Associated with Each of Content)

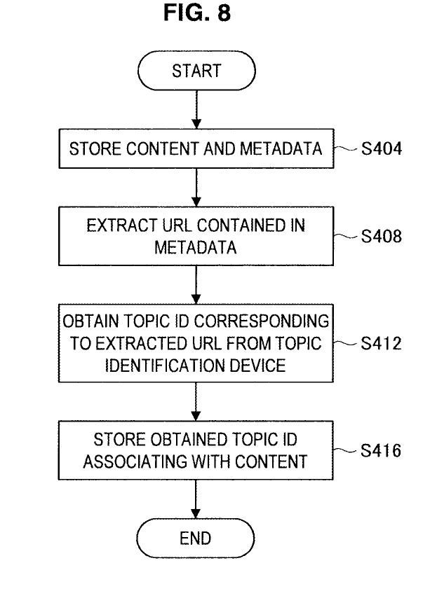

FIG. 8 is a flow chart for illustrating how the client terminal 20 associates each content with a topic ID. As shown in FIG. 8, at first, the content storage unit 224 of the client terminal 20 stores the content obtained by the client terminal 20 and metadata of the content (S404). Here, an URL contained in the metadata is highly possible to be a URL of the official website of the content. Moreover, the client terminal 20 may obtain metadata transmitted superimposing on the content as an Electronic Program Guide (EPG) from a broadcasting station, or it may obtain from a service which provides metadata.

Next, the information extraction unit 220 extracts the URL contained in the metadata (S408). Then, the identification request unit 228 requests the topic identification device 10 for a topic ID associated with the extracted URL (S412). Specifically, the identification request unit 228 transmits the URL extracted in S408 to the topic identification device 10, and the identification unit 128 of the topic identification device 10 searches, from data for topic identification, the topic ID associated with the URL that is received from the identification request unit 228 to transmit to the client terminal 20. After that, the content storage unit 224 of the client terminal 20 stores the topic ID that is obtained by the identification request unit 228 in association with the content (S416).

Thus, by transmitting an URL of Web data regarding content to the topic identification device 10, the client terminal 20 can obtain the topic ID of the Web data from the topic identification device 10, and store the topic ID in association with the content.

(4-3. Process of Topic Identification)

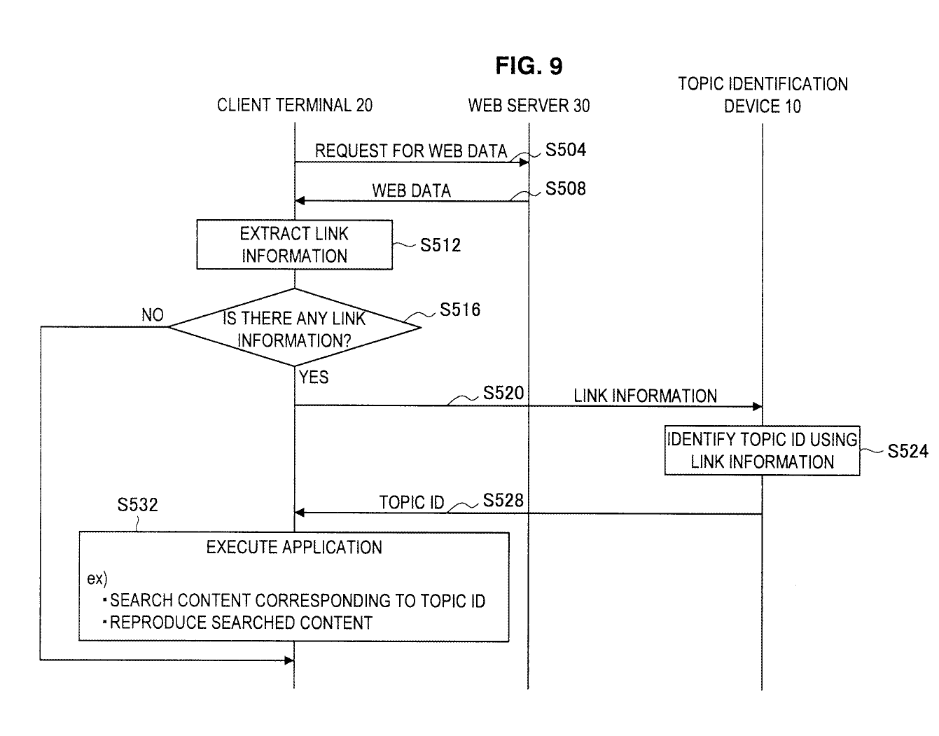

FIG. 9 is a sequence diagram for illustrating a process of topic identification by the client terminal 20 and the topic identification device 10. The process of topic identification in the client terminal 20 is a process built in an application of the client terminal 20 and is to be started as the application instructs. For example, when the application is to search content related to a topic of Web page on the network 12 from a lot of contents to recommend to a user, the process of topic identification is to be performed when the application regularly obtains topic on the network 12.

Specifically, as shown in FIG. 9, the client terminal 20 requests the Web server 30 for Web data (S504), and obtains the Web data from the Web server 30 (S508). Here, the client terminal 20 may obtain the Web data from a website registered in advance. For example, the client terminal 20 may obtain an article in his/her friend's blog as Web data when a user of the client terminal 20 registered the friend's blog site. Or, the client terminal 20 may obtain an article in a highly popular blog as Web data.

After the step S508, the information extraction unit 220 of the client terminal 20 analyzes the Web data obtained in S508, and extracts link information (URL) contained in the Web data (S512). For example, if the Web data is in the HTML format, the information extraction unit 220 extracts a tag related the link from the tags in HTML file. Moreover, the information extraction unit 220 extracts not only link tags, but also information of an image or the like that refers to external websites

When the link information is extracted by the information extraction unit 220 (S516), the identification request unit 228 requests the topic identification device 10 for topic identification of the Web page obtained in S508 (S520). Specifically, the identification request unit 228 transmits request information including the link information extracted by the information extraction unit 220 to the topic identification device 10.

Then the identification unit 128 of the topic identification device 10 identifies a topic using the link information included in the request information received from the client terminal 10 (S524), and transmits the topic ID extracted through the topic identification to the client terminal 20 (S528). Specifically, the identification unit 128 searches, from the data for topic identification storage unit 124, data for topic identification containing an URL identical to the link information from the client terminal 20, and extract the topic ID contained in the data for topic identification. For example, when the data for topic identification storage unit 124 stores the data for topic identification shown in FIG. 7 and link information from the client terminal 20 is “http://www.com/”, data for topic identification whose management ID is “1” is to be searched, and the topic ID “10001” contained in the data for topic identification is to be extracted.

Further, if data for topic identification containing an URL identical to the link information from the client terminal 20 are not found, the identification unit 128 searches the data for topic identification containing the URL partially identical to the link information to extract a topic ID included in the data for topic identification. For example, when the URL identical to “http://zzz.co.jp/xxx/yyy/” is not found, the identification unit 128 shortens a path of the URL into “http://zzz.co.jp/xxx/”, and searches an URL identical to “http://zzz.co.jp/xxx/”. If the URL identical to “http://zzz.co.jp/xxx/” is not found either, the identification unit 128 further shortens the path of the URL into “http://zzz.co.jp/”, and searches an URL identical to “http://zzz.co.jp/”.

Note that the request information from the client terminal 20 may include a plurality of link information. In this case, the identification unit 128 may extracts preferentially the topic ID common with more number of pieces of link information. For example, if the request information includes five pieces of link information wherein three of them are related to the “Buzzer Beater”, and the rest of two pieces of link information are related to other topic, the identification unit 128 may extract preferentially the topic ID of “10001” which is associated with the “Buzzer Beater”.

After the step S528, the identification request unit 228 of the client terminal 20 analyzes a response from the topic identification device 10 to the request. Specifically, the identification request unit 228 analyzes XML data, for example, which is obtained as a response from the topic identification device 10, and extracts a topic ID.

This enables the client terminal 20 to perform various applications using the topic ID identified by the topic identification device 10 (S532). For example, the search unit 232 searches, from the content storage unit 224, content associated with the identified topic ID, and the reproduction unit 236 reproduces the searched content, which makes it possible to recommend a user content relating to the hot topic on the network 12.

### 5. MODIFIED EXAMPLE

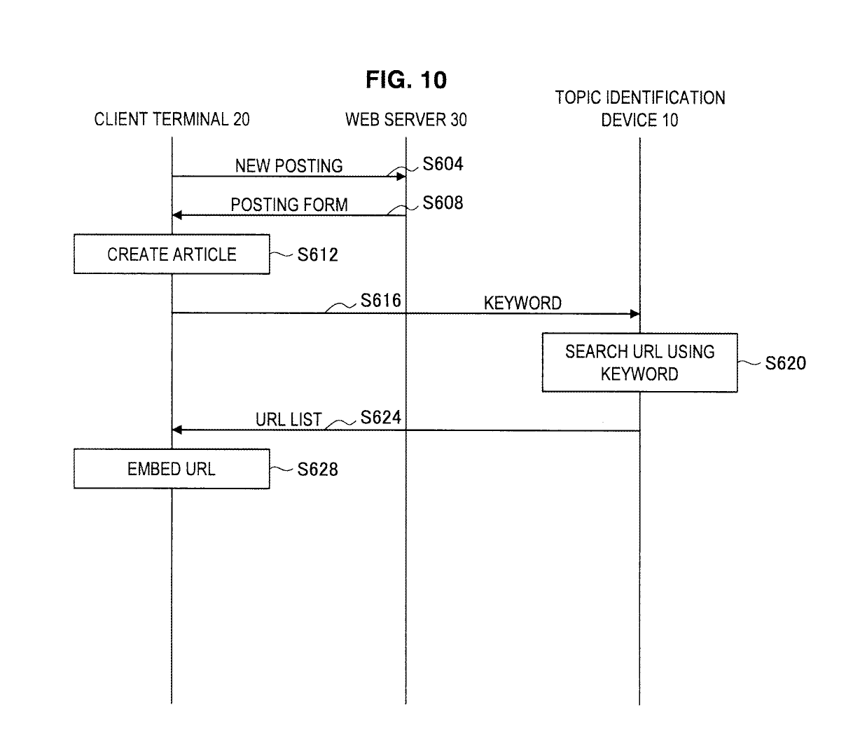

Heretofore, a case where the topic identification device 10 has a function of topic identification, and where the topic identification device 10 is used for topic identification of Web page has been explained, however, the present invention is not limited to this example. For example, the topic identification device 10 can be used to edit an article on a blog or SNS site. Specifically, when creating an article with reference to the official website, as explained referring to FIG. 10, an URL of the official Website and an URL of an image can be obtained from the topic identification device 10 to be embedded into the article.

FIG. 10 is a sequence diagram for illustrating a modified example of an operation by the topic identification system 1. As shown in FIG. 10, the client terminal 20 accesses to the Web server 30 when newly posting (S604), and obtains a posting form for newly posting from the Web server 30 (S608). Then, when the user creates an article in accordance with the posting form in the client terminal 20 (S612), it is assumed that the user desires to embed the URL of the Web data relating to the topic of the article into the article as link information.

In this case, the identification request unit 228 of the client terminal 20 transmits the request information including keywords specified by the user to the topic identification device 10 (S616). Then, the identification unit 128 of the topic identification device 10 searches, from the data for topic identification storage unit 124, an URL relating to the keywords contained in the request information (S620), and transmits the searched URL list to the client terminal 20 (S624).

For example, when the user is writing an article relating to the drama “Buzzer Beater”, the user transmits the request information including the keyword of “Buzzer Beater” from the client terminal 20 to the topic identification device 10. Then, the topic identification device 10 searches, in titles of the data for topic identification, the keywords included in the request information, groups the URLs associated with the searched title by topic ID to transmit to the client terminal 20.

After the step S624, the client terminal 20 selects the desired URL from the URLs received from the topic identification device 10, and embeds the selected URL into the article (S628). For example, the client terminal 20 can pastes an URL of the official website into the article as link information, or pastes images of scenes in a drama.

According to such application of the modified example, it is possible to easily paste link information and images into the article to be posted without researching each of URLs of the official Website and images. Moreover, as such application will increase, URLs accumulated in the topic identification device 10 is to be pasted into Web data in blogs and SNS sites, which makes it easier to identify a topic. The synergistic effect like this would be expected.

### 6. CONCLUSION

According to the embodiment described above, it is possible to identify a topic of Web data of a blog and a SNS site open to the public on the network 12, using link information and an URL of image contained in the Web data. Therefore, even if a notation or an expression in a description of the Web data is different from the usual ones, it is possible to appropriately identify the topic of the Web data.

According to the embodiment, an URL of a plurality of different Web pages regarding the same target topic is managed in the topic identification device 10 in associating with the same topic ID. Therefore, even if link information contained in a plurality pieces of Web data regarding to the same topic are different, it is possible to identify that the topic of these Web data is the same. Moreover, according to the modified example above, by using the topic identification device 10 as a device for identifying an URL, it is possible to paste easily link information and images into an article to be posted without researching each of URLs of the official website and images.

A preferred embodiment of the present invention has been explained in detail above with reference to the attached drawings, the present invention is not limited to this example. It should be understood by those skilled in the art that various modifications, combinations, sub-combinations and alterations may occur depending on design requirements and other factors insofar as they are within the scope of the appended claims or the equivalents thereof.

For example, each step in the processes of the topic identification system 1 and the client terminal 20 is not necessarily processed in the order of time series described in sequence diagrams or flow charts. For example, each step of the processes of the topic identification system 1 and the client terminal 20 may be processed in a different order from the order described in the sequence diagrams or the flow charts, or may be processed in parallel.

Moreover, it is also possible to create a program to cause hardware such as the CUP 201, the ROM 202 and the RAM 203, or the like built in the topic identification device 10 and the client terminal 20, to fulfill the functions equivalent to the ones in each of configurations of the above-described topic identification device 10 and the client terminal 20. Further, a storage medium to store the computer program is to be provided.

The present application contains subject matter related to that disclosed in Japanese Priority Patent Application JP 2009-264239 filed in the Japan Patent Office on Nov. 11, 2009, the entire content of which is hereby incorporated by reference.

What is claimed is:

1. A topic identification system comprising:
a client terminal including:
a link information extraction unit for extracting link information contained in Web data arranged on a network; and
a communication unit for transmitting the link information extracted by the link information extraction unit, and
a topic identification device including:
a collecting unit for collecting location information of Web data related to a target topic;
a storage unit for storing identical topic identifying information in association with one or more than two pieces of location information related to an identical target topic, which have been collected by the collecting unit;
a receiving unit for receiving the link information transmitted from the communication unit of the client terminal;
an identification unit for searching location information from the storage unit using the link information received by the receiving unit, and for identifying topic identifying information associated with the searched location information; and
a transmitting unit for transmitting the topic identifying information identified by the identification unit to the client terminal.

2. The topic identification system according to claim 1,
wherein the collecting unit calculates a degree of importance of each of the collected location information, and determines whether the degree of importance of each of the location information exceeds a prescribed benchmark; and
wherein the storage unit stores the topic identifying information in association with the location information determined that the degree of importance has exceeded the prescribed benchmark.

3. The topic identification system according to claim 2,
wherein the identification unit searches, from the storage unit, location information that is identical to the link information received by the receiving unit, and searches location information that is partially identical to the link information in a case where there has been found no location information that is identical to the link information.

4. The topic identification system according to claim 3,
wherein the collecting unit collects location information of Web data related to the target topic based on keywords of the target topic,
wherein the storage unit further stores one or more than two pieces of location information related to an identical target topic, which have been collected by the collecting unit, in association with keywords of the target topic,
wherein the identification unit searches, from the storage unit when a keyword is received from the client terminal, location information associated with topic identifying information containing the keyword, and
wherein the transmitting unit transmits the location information searched by the identification unit to the client terminal.

5. The topic identification system according to claim 3,
wherein the client terminal further includes:
a content storage unit for storing content in association with topic identifying information; and
a search unit for searching, from the content storage unit, content associated with the topic identifying information transmitted by the topic identification device.

6. The topic identification system according to claim 5,
wherein the client terminal transmits location information contained in metadata of the content to the topic identification device, receives topic identifying information identified through a search using the location information from the topic identification device, and causes the storage unit to store the content in association with the received topic identifying information.

7. A topic identification device comprising:
a collecting unit for collecting location information of Web data related to a target topic arranged on a network;
a storage unit for storing identical topic identifying information in association with one or more than two pieces of location information related to an identical target topic, which have been collected by the collecting unit; and
an identification unit for obtaining link information contained in certain Web data, for searching location information from the storage unit using the link information, and for identifying topic identifying information associated with the searched location information.

8. A client terminal comprising:
a link information extraction unit for extracting link information contained in Web data arranged on a network;
a receiving unit for transmitting the link information extracted by the link information extraction unit to a topic identification device storing identical topic identifying information in association with location information of Web data related to an identical target topic, and for receiving topic identifying information identified through a search using the link information from the topic identification device;
a content storage unit for storing content in association with topic identifying information; and
a search unit for searching, from the content storage unit, content associated with topic identifying information received from topic identification device.

9. A program causing a computer to function as:
a collecting unit for collecting location information of Web data related to a target topic arranged on a network;
a storage unit for storing identical topic identifying information in association with one or more than two pieces of location information related to an identical target topic, which have been collected by the collecting unit; and
an identification unit for obtaining link information contained in certain Web data, for searching location information from the storage unit using the link information, and for identifying topic identifying information associated with the searched location information.

10. A program causing a computer to function as:
a link information extraction unit for extracting link information contained in Web data arranged on a network; and
a receiving unit for transmitting the link information extracted by the link information extraction unit to a topic identification device storing identical topic identifying information in association with location information of Web data related to an identical target topic, and for receiving topic identifying information identified through a search using the link information from the topic identification device;
a content storage unit for storing content in association with topic identifying information; and
a search unit for searching, from the content storage unit, content associated with topic identifying information received from topic identification device.

11. A topic identifying method comprising the steps of:
collecting location information of Web data related to a target topic arranged on a network;
storing identical topic identifying information into a storage medium in association with one or more than two pieces of location information related to an identical target topic, which have been collected;
obtaining link information contained in certain Web data, and for searching location information from the storage unit using the link information; and
identifying topic identifying information associated with the searched location information.

12. An information processing method comprising the steps of:
extracting link information contained in Web data arranged on a network;
transmitting the extracted link information to a topic identification device storing identical topic identifying information in association with location information of Web data related to an identical target topic;
receiving topic identifying information identified through a search using the link information from the topic identification device; and
searching content associated with topic identifying information received from the topic identification device, from a storage medium storing content in association with topic identifying information.
